(19) United States
(12) Patent Application Publication
(10) Pub. No.: US 2022/0193668 A1
(43) Pub. Date: Jun. 23, 2022

(54) INTEGRATED MICROFLUIDIC DEVICE WITH PIPETTE ADAPTATION

(71) Applicant: Siemens Healthcare Diagnostics Inc., Tarrytown, NY (US)

(72) Inventor: David John Guckenberger, Jr., Oakland, CA (US)

(73) Assignee: Siemens Healthcare Diagnostics Inc., Tarrytown, NY (US)

(21) Appl. No.: 17/593,561

(22) PCT Filed: Jan. 21, 2020
(86) PCT No.: PCT/US20/14376

§ 371 Date: Sep. 21, 2021

Related U.S. Application Data
(60) Provisional application No. 62/835,602, filed on Apr. 18, 2019.

(51) Int. Cl. B01L 3/00; B01L 3/02

(52) U.S. Cl. CPC B01L 3/502715; B01L 2300/0832; B01L 2300/0819; B01L 3/0279

(57) ABSTRACT

An integrated microfluidic unit with pipette adaptation. The integrated microfluidic unit may be accommodated within a pipette tip rack for storage prior to use and may be received by a translating pipette head during use. The number of components required within the laboratory instrument is reduced compared to processes employing discrete microfluidic chips and pipette tips. Processes involving microfluidic devices integrated into the presently disclosed unit are streamlined at least by the elimination of discrete manipulation steps associated with aspirating sample fluid into a pipette tip, then using a discrete chip feeder or manipulator to bring the chip and pipette tip into fluidic communication for transfer of the sample to the chip. The number of consumables is also reduced by the integration of microfluidics with physical features enabling fluid aspiration and unit conveyance. A variety of microfluidic devices and channel configurations may be accommodated.

### CROSS-REFERENCE TO RELATED APPLICATIONS

N/A

### FIELD OF THE DISCLOSURE

The disclosure herein relates generally to the field of microfluidic devices for chemical analysis of biological samples in a laboratory environment, including devices adapted for thermal cycling reactions and optical analysis. More particularly, the present disclosure relates to a microfluidic chip integrated with aspects of a pipette tip suitable for use with currently practiced lab-on-a-chip analytical processes.

### BACKGROUND

Microfluidic systems are utilized to perform various chemical and biochemical analyses and syntheses, both for preparative and analytical applications. Such miniaturized systems enable analyses and syntheses to be conducted on a macro scale while minimizing the quantity of sample required. A substantial reduction in time, cost, and space requirements for the devices utilized to conduct the analyses or syntheses is achieved through the use of microfluidic devices. Additionally, microfluidic devices have been adapted for use with automated systems providing cost efficiency and decreased operator errors because of the reduction in human involvement. Microfluidic devices have been used in a variety of applications, including, for instance, capillary electrophoresis, gas chromatography, cell separations, and DNA amplification.

While automated, high throughput laboratory instruments can provide great efficiencies in terms of speed, sample minimization and repeatability, costs associated with the large number of consumables required for their use can be significant. Reducing the number of consumables can significantly reduce the costs associated with running an instrument within a laboratory. Microfluidic devices, sometimes referred to as a labs-on-a-chip or simply as chips, may represent one type of consumable that makes a significant contribution to the operational cost of a laboratory instrument. These devices are becoming increasingly common, especially for molecular diagnostics. Use of a chip requires not only the chip itself, but other consumables and chip specific components as well.

For example, a pipette tip or custom filling apparatus with associated fluid conveying tubes is required to fill the chip. A feature such as a funnel-shaped aperture is provided on the chip for receiving the pipette tip or filling apparatus. In the case of the latter, multiple features may be provided on the chip for receiving various fluids. Insertion of the pipette tip or filling apparatus into the feature must be performed with great precision in order to achieve a fluid tight seal to avoid leakage and the introduction of air into the sample. The sample is then injected into the interior microfluidic channels of the chip.

Use of a traditional chip may involve the following sequence of steps. A chip is typically one of many located within a magazine or holder for an automated instrument. A manipulator or feeder grabs a portion of the chip and relocates it into a loading zone. A separate pipette head simultaneously or sequentially acquires a pipette tip. A source of vacuum is connected to the pipette tip via the pipette head and a small volume of sample fluid is aspirated into the pipette tip. The pipette head and/or chip manipulator translates to align the pipette tip with an orifice on the chip, then presses the pipette tip into the chip. A press fit connection may enable a secure, fluid-tight mating of the two disposables. The sample fluid is then dispensed from the pipette tip into the chip, such as through cessation of the applied vacuum or application of positive pressure. Once a required volume of sample fluid has been deposited into the chip, the pipette head removes the pipette tip from the chip and the pipette tip is released into a waste container.

The now-filled chip may then be moved by the manipulator to a heat sealer to seal the sample fluid within the chip and to prevent evaporation. Next, the chip may be moved by the manipulator to a downstream processing station, which may be one in a sequence of stations. The chip may undergo processes such as thermal cycling and detection, such as through optical imaging. Once the analysis of the respective sample is complete, the chip is then moved by the manipulator to a waste container.

The plurality of components involved in this exemplary process and the number of steps required contribute to both the cost per test and as well as the length of time required for each test. Innovations directed at streamlining automated analysis and minimizing the number of consumables would be highly desirable.

### SUMMARY

In order to overcome the complexity of the prior art automated processes involving lab-on-a-chip microfluidic devices and to reduce the number of consumables found in such prior art processes, the present disclosure provides for an integrated microfluidic unit with pipette adaptation. The integrated microfluidic unit is preferably configured to be accommodated within a state of the art pipette tip rack for storage prior to use, on the one hand, and to be received by a standard translating device, such as a pipette head or syringe, during use, on the other hand.

Provision of the integrated microfluidic unit reduces the number of components required within the laboratory instrument. A manipulator or feeder required for moving a microfluidic chip from a magazine/feeder is eliminated, as is the magazine itself. Rather, the integrated microfluidic unit lower extent has a form factor resembling that of the lower extent of a standard pipette tip, and thus is readily accommodated within a standard high density array pipette tip rack, such as an 8×12 array.

The upper extent of the integrated microfluidic unit has a form factor similar to that of the upper extent of a standard pipette tip, and thus is mechanically and fluidically engaged by a standard pipette head.

The approach of the present disclosure is adaptable to a variety of specific microfluidic devices and channel configurations. For example, the size of the openings at the top and/or bottom of the integrated microfluidic unit may vary depending upon the volume and type of fluid to be aspirated or the size of the pipette head or other manipulator. The overall concept of an integrated microfluidic unit is the same.

Processes involving use of microfluidic devices integrated into the presently disclosed unit are streamlined at least by the elimination of discrete manipulation steps associated with aspirating sample fluid into the pipette tip, then using a discrete chip feeder or manipulator to bring the chip and pipette tip into fluidic communication for transfer of the sample to the chip.

Elimination of the requirement for bringing the chip from the respective magazine to the pipette bearing the sample thus eliminates the need for a discrete chip manipulator or feeder. Cost and complexity are thus significantly reduced.

The number of consumables is also reduced. Rather than requiring a discrete pipette tip for aspirating sample fluid and then transporting it to the chip, sample fluid can be aspirated directly into the integrated microfluidic unit. Consumables are thus reduced by a factor of 50%.

In addition to simplifying the retention and filling of a microfluidic circuit through the provision of an integrated device as discussed above, a further embodiment discussed herein includes the ability to sever the microfluidic circuit after filling, mixing, and sealing steps, as applicable.

### BRIEF DESCRIPTION OF THE DRAWINGS

Illustrative embodiments of the disclosed technology are described in detail below with reference to the attached drawing figures, which are incorporated by reference herein and wherein:

FIG. 1 is a perspective view of pipette tip according to the prior art;

FIG. 2 is an elevation view of the pipette tip of FIG. 1 disposed within a prior art tip rack (shown in cut-away view);

FIG. 3 is a perspective view of an integrated microfluidic unit according to the present disclosure;

FIG. 4 is an elevation view of the integrated microfluidic unit of FIG. 3 disposed within a prior art tip rack (shown in cut-away view);

FIGS. 5A, 5B, and 5C are perspective views of the integrated microfluidic unit of FIG. 3 illustrating internal channels and respective fluid flow paths;

FIG. 5D is a perspective view of a variant of the integrated microfluidic unit of FIG. 3 also having fracturable regions;

FIG. 6 is a flowchart of a method of manipulating a sample using the integrated microfluidic unit of FIG. 3; and

FIG. 7 is a flowchart of a method of analyzing a sample using the integrated microfluidic unit of FIG. 3.

### DETAILED DESCRIPTION

Disclosed herein is an integrated microfluidic unit (IMU) 200 with pipette adaption. Use of the IMU enables simplified mechanical requirements for laboratory instrumentation and streamlines processes with which it is used. The number of consumables is also significantly reduced.

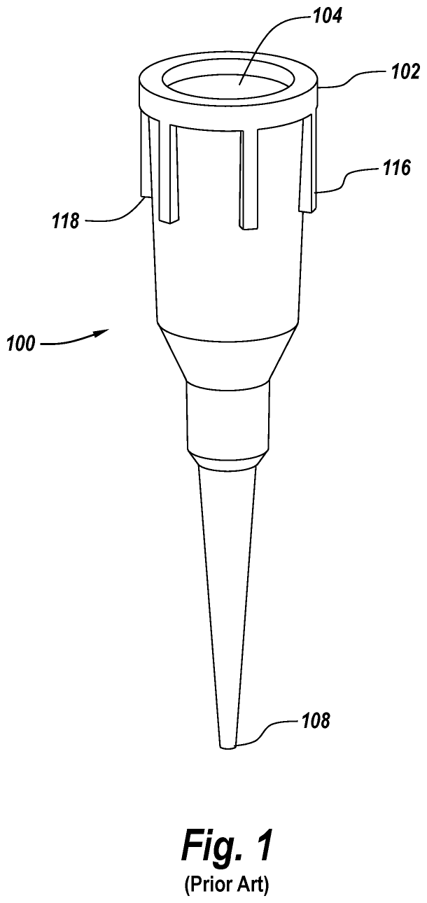

A prior art pipette tip 100, commonly used in laboratory analytical applications, is depicted in FIG. 1. The tip comprises a proximal end 102 having a socket 104 for receiving a translatable pipette head therein. In one embodiment, the translatable pipette head is a state of the art pipette head known to one skilled in the art. The tip may be retained on the pipette head through friction fit and/or through the provision of mechanical features on one or both of the socket surface or pipette head surface. The tip is selectively removable such as through manipulating the pipette head to bring the pipette tip proximal end into physical contact with a rigid surface, then raising the pipette head, the rigid surface preventing upward movement of the tip, resulting in the separation of the tip from the pipette head. The used tip may then be disposed.

The lower extent of the prior art tip 100 includes a tapered distal end 108 having an axially aligned fluid channel (not shown) in fluid communication with the socket 104 interior. Thus, a continuous fluid channel is formed within the pipette tip from the distal end to the top of the socket. Once fitted to a pipette head, a source of vacuum applied by the pipette head extends through the pipette tip to the distal end. Typically, the distal end is tapered, narrower at the most distal portion of the distal end, in order to facilitate being disposed with a fluid container. Once so disposed through mechanical manipulation of the pipette head, a source of vacuum may be applied and a sample of fluid may be aspirated into the tip through the distal end.

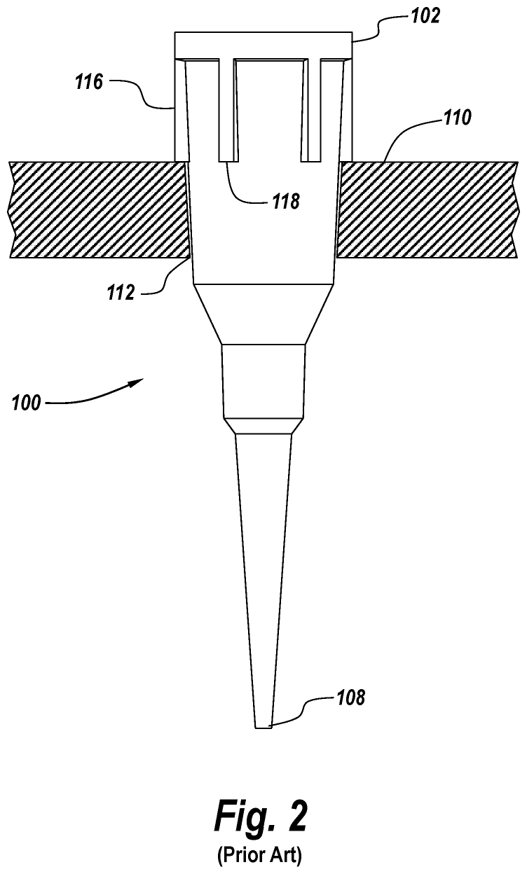

Pipette tips 100 are typically stored in a state of the art pipette tip rack, which may enable the provision of an array of tips. In FIG. 2, a prior art pipette tip is shown disposed within a portion of a pipette tip rack 110. A rack may be provided with an array, such as an 8×12 array, of pipette tip receiving holes 112. Each tip is suspended within the respective hole through the provision of abutments 116 about the proximal end 102 of the tip. Each abutment is provided with a downwardly facing surface 118, all of the downwardly facing surfaces lying substantially within a horizontal plane when the respective pipette tip is vertically oriented. The abutments and the respective downwardly facing surfaces extend outwardly from the outer surface of the proximal end of the tip. Thus, when the tip is disposed within a rack, the downwardly facing surfaces are configured to rest upon an upper surface of the rack and prevent the tip from falling through the rack.

Certain laboratory instruments utilize lab-on-a-chip (LOC) microfluidic circuits, referred to herein as microfluidic chips or simply as chips, to carry out certain analyses on target fluid samples. These chips may be stored in magazines or racks proximate to a respective instrument. In such a case, an electromechanical manipulator is required to retrieve a chip, dispose it at a testing or other process location, then retrieve and dispose of the chip after testing or processing. Alternatively, such chips may be manually retrieved and located with respect to the laboratory instrument.

In either case, once the chip has been disposed at the proper location, an electromechanical actuator such as a pipette head retrieves a pipette tip 100, positions it with respect to a fluid container, and aspirates a sample into the pipette tip. The pipette tip is then moved from the fluid container to the respective chip. Typically, an aperture or other funnel-shaped feature is provided on an upwardly facing surface of the chip. The pipette tip is disposed in vertical alignment with the aperture, then moved downward into fluid- and air-tight contact between the distal end 108 and the chip aperture. Sample may then be injected into the chip and the desired process may be executed. Once processing is complete, both the tip is disposed of, as described above, and the chip is disposed of, such as through further actuation of the electromechanical actuator, if provided.

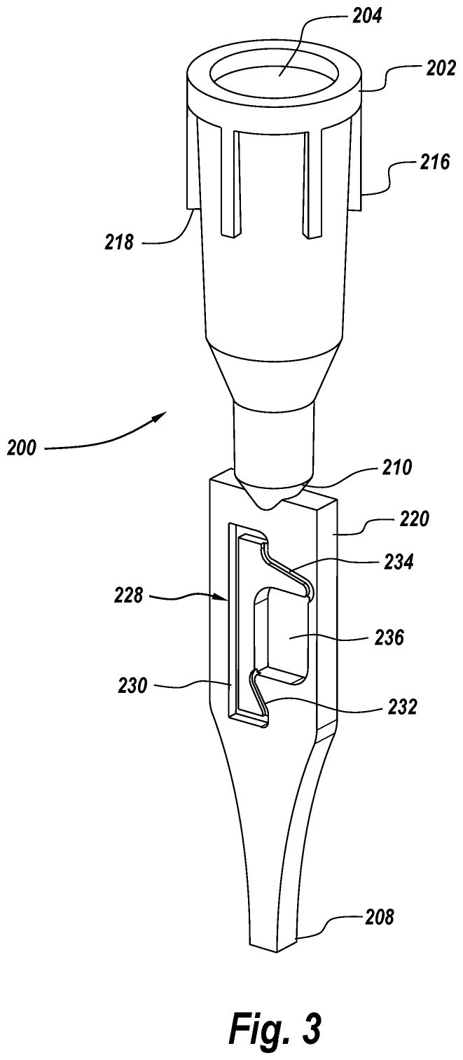

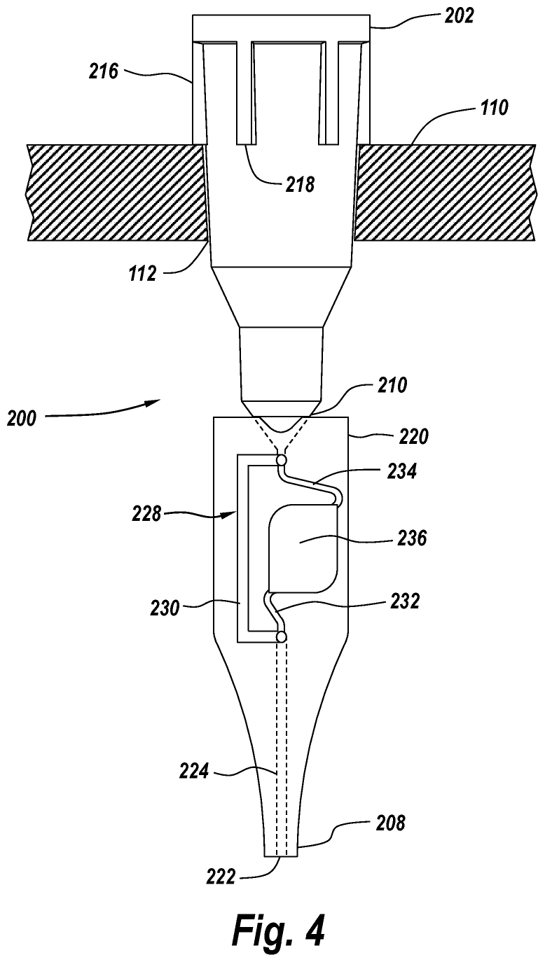

According to the present disclosure, aspects of a pipette tip and LOC microfluidic circuit may be combined into the IMU 200, as shown in FIGS. 3 and 4. Advantages of such a configuration include the ability to mimic functional aspects of a prior art pipette 100. For example, an upper or proximal end 202 of the IMU, including a socket 204, is dimensioned to accommodate a translating manipulator such as a standard pipette head and to be retained thereon through friction fit or through the provision of mechanical mating features (not shown) on one of the pipette head, the socket interior, or both. The socket may alternatively be referred to as a manipulator interface.

In another embodiment, the socket 204 may be received within a translating syringe, also known to one skilled in the art. A translating pipette head and syringe are commonly found in association with diagnostic instruments. Even though any standard translating interface having the ability aspirate through an IMU 200 attached thereto may be utilized in the present disclosure, reference is made primarily to a pipette head for consistency and clarity.

The IMU preferably also has outer dimensions for fitting within a hole 112 in a standard pipette tip rack 110 and abutments 216 having downwardly facing surfaces 218 dimensioned to prevent the IMU from falling through the respective tip rack hole. Thus, the upper extent of the proximal end is substantially cylindrical. In one embodiment, the upper extent includes a slight taper that narrows when moving away from the socket 204.

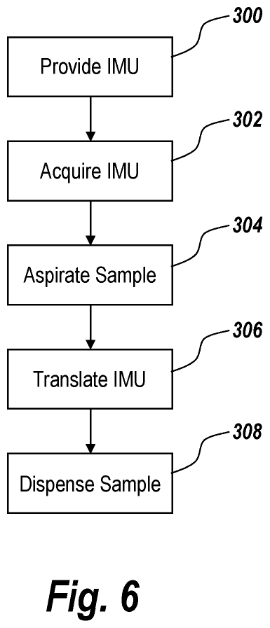

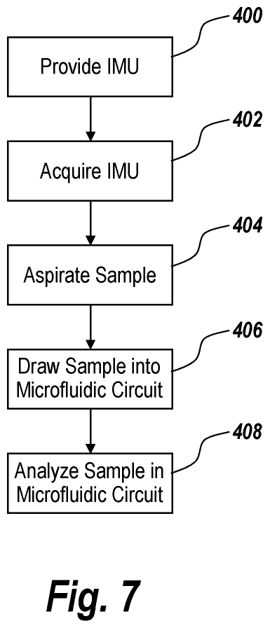

Preferably, in a method utilizing the IMU 200 for sample manipulation or analytical processes as illustrated in FIGS. 6 and 7, one or more IMUs are provided 300, 400, such as within a standard pipette tip or other common rack 110.

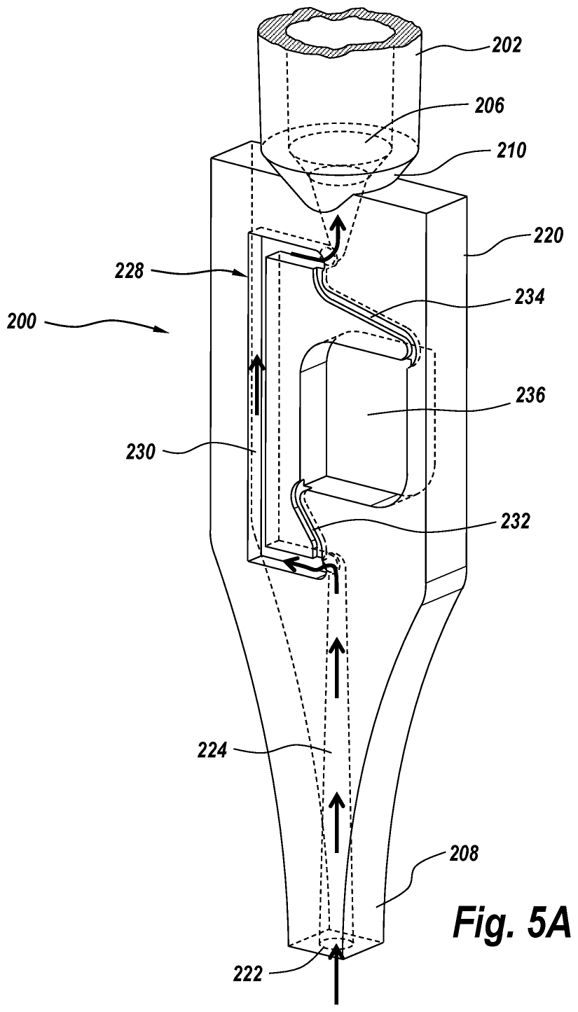

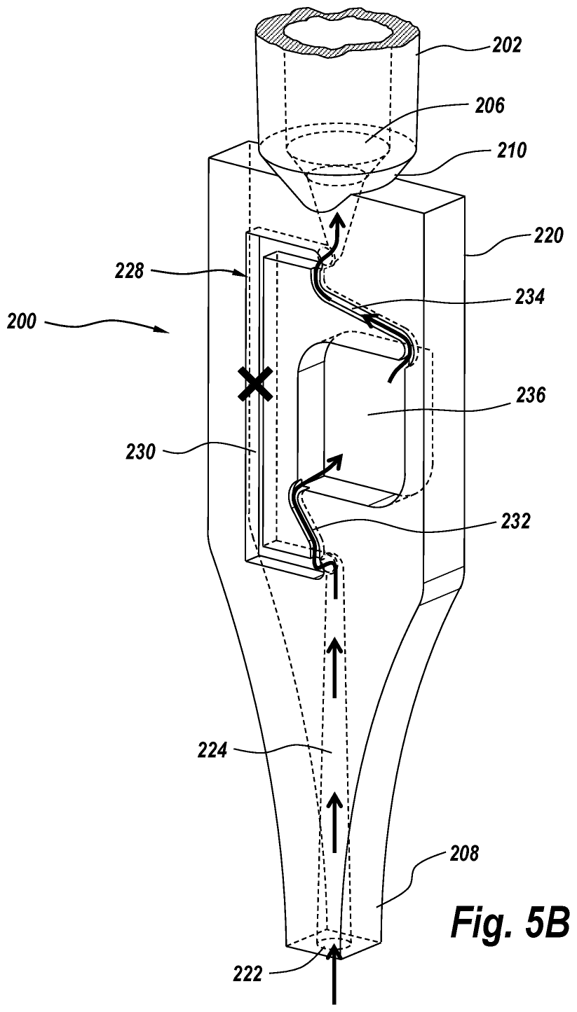

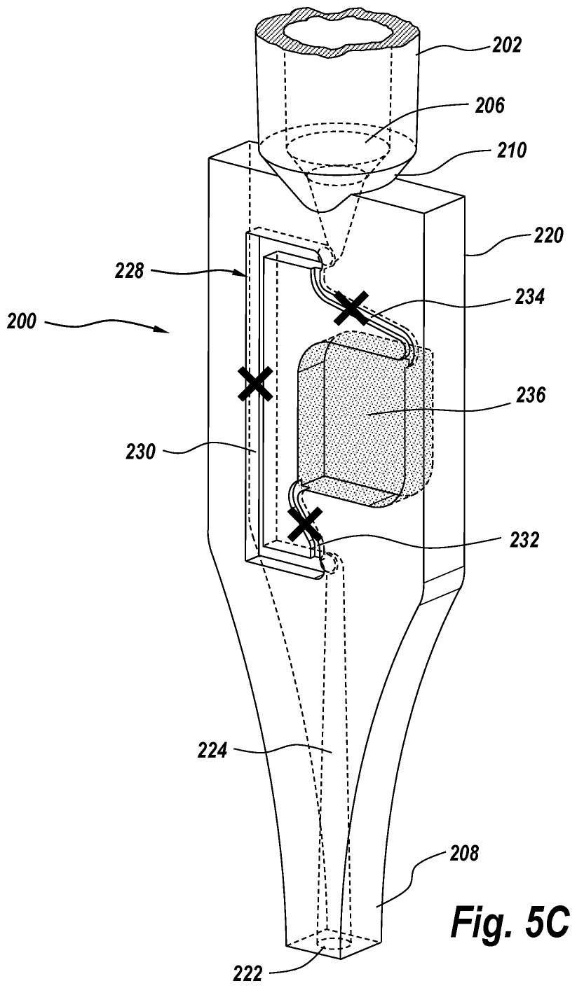

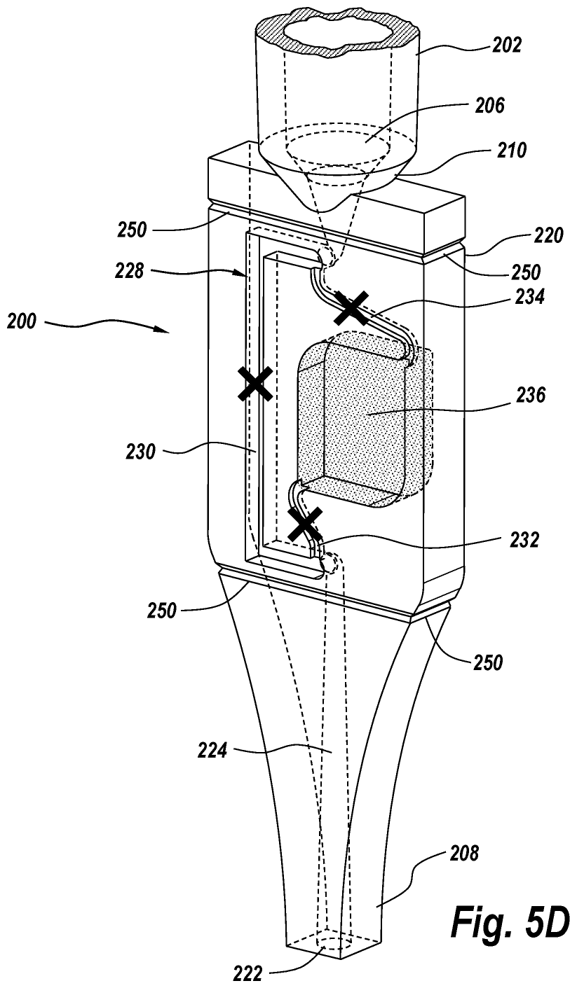

The socket 204 of the proximal end 202 is in fluid communication with a proximal end interior fluid channel 206, as seen in FIGS. 5A-5D. The proximal end interior fluid channel may alternatively be referred to as an outlet fluid channel. The lower extent of the proximal end includes a body interface 210.

The IMU 200 may be manipulated by a standard translating pipette head or syringe, as opposed to requiring a separate manipulator or feeder such as typically required for movement of discrete chips. Assuming a body region 220, housing the microfluidic circuit 228, is dimensioned to have a maximum width that is equal to or less than the diameter of a pipette rack hole 112, the IMU may be stored within a standard tray or rack 110, such as a pipette tip tray. This hole diameter is typically on the order to ˜6 mm. The body region may be planar or flat, as shown, or may be rounded or otherwise shaped, according to the intended application. The pipette head is translated to a position vertically aligned with a target IMU, then lowered in order to mechanically engage with the IMU. With respect to FIGS. 6 and 7, the IMU is thus acquired 302, 402.

The distal end 208 of the IMU 200 illustrated in FIGS. 3 and 4 has a tapered square or rectangular vertical projection particularly suited for being disposed within a fluid-bearing well, tube or container. However, the form factor for the distal end may be modified according to specific requirements of the analyses performed within the IMU, the functions that the IMU enables, fluid volumes to be aspirated and dispensed, and other reasons such as manufacturability and cost savings. Preferably, the outer dimensions of the distal end are less than the diameter of a hole 112 in a standard tray or rack 110, such as a pipette tip tray, to facilitate IMU storage in and retrieval from such a tray, although other storage facilities may be employed.

The microfluidic circuit 228 in the body region 220 of the IMU 200 may be configured according to a variety of parameters. In the illustrated embodiment, an IMU particularly suited for a polymerase chain reaction (PCR) application is provided. Such a circuit enables multiple functions, including a pipette-like fluid transfer and manipulation function (FIG. 6), and a microfluidic function, such as treating and storing a sample for downstream processing (FIG. 7).

Sample fluids may be aspirated into a tip aperture 222, or inlet, disposed at the end of the distal end 208 of the IMU 200 and into an interior inlet fluid channel 224, such as shown in FIG. 5A. In the illustrated embodiment, a first channel 230 within the body region has larger cross-sectional dimensions as compared to second and third channels 232, 234. Thus, once the distal end 208 is disposed within a fluid container by manipulation or transfer of the pipette head engaging the proximal end 202 of the IMU 200 and a source of vacuum is applied through the pipette head (or other translating and aspirating device), into the socket 204 of the proximal end, a quantity of sample fluid is drawn through the inlet channel and into the first channel of the microfluidic circuit 228. The sample is thus aspirated 304, 404, with respect to the method illustrated in FIGS. 6 and 7.

The first channel 230 has a lower resistance to fluid flow as compared to the second and third channels 232, 234 due to its larger internal dimensions. Here, the sample may be retained as the IMU 200 is translated 306 to a desired location by the pipette head, following which the sample may be dispensed 308 from the first channel, the inlet channel 224, and the aperture 222 in the distal end 208. Optionally, the first channel, or some other portion of the microfluidic circuit, may contain one or more reagents which are mixed with the sample upon aspiration and prior to being dispensed. Multiple fluids may also be aspirated and mixed.

The larger first channel 230 may also be sealed to prevent leakage, evaporation, or contamination. Sealing may be achieved through the targeted application of heat using a thermal probe. Alternatively, a form of barrier such as oil, wax, or an adhesive, may be employed. A sealed channel is illustrated schematically in FIG. 5B by the letter X. Application of vacuum at the proximal end 202 would thus result in sample being aspirated 406 through the second channel 232 into a reservoir 236. Advantageously, aspiration of sample within the IMU 200 as disclosed is performed from below. Gravity thus facilitates the displacement and removal of air from the reservoir and such a microfluidic circuit 228 as it rises ahead of the aspirated sample. Air bubble formation and entrapment is also inhibited in this manner.

Once sample has been aspirated into the reservoir 236, the reservoir may be sealed by sealing both the second and third channels 232, 234, as depicted in FIG. 5C, using a similar technique or a combination of techniques. The microfluidic circuit 228 may then be thermally cycled, analyzed, and/or imaged 408 without risk of sample evaporation or loss. In addition, or in the alternative, the tip aperture 222 may be sealed to help mitigate a risk of contamination of an instrument to which the IMU 200 is interfaced.

While it is recognized that the disclosed IMU 200 only requires a single manipulator such as a pipette head or syringe both for movement with respect to a laboratory instrument or environment and for sample aspiration directly into a microfluidic circuit, downstream processing may require or may be optimized if the body portion 220 housing the microfluidic circuit 228 is physically separated from the proximal end 202 and distal end 208 of the IMU 200. This may be achieved in a variety of ways. In FIG. 5D, plural fracturable regions 250 are provided roughly at the boundaries between the proximal end 202 and the body portion 220 and between the body portion and the distal end. The fracturable regions may be located at other locations, however. For example, a physical feature or plural features may be disposed at the body interface 210, such as fracturable regions, perforations, or weakened bonds between the proximal end 202 and the body portion 220.

In one embodiment, as shown in FIG. 5D, the fracturable regions are thinner, scored regions. The distal end 208 may be separated from the body portion 200 such as by inserting the distal end into a socket, crevice or other opening dimensioned to receive the distal end, then using the manipulator engaged with the proximal end 202 to apply a torque about the lower fracturable region 250. In such a case, the material chosen for the IMU 200 would not be overly brittle, such as polyethylene or polypropylene.

The body portion 220 can then be disposed at a further processing station with the proximal end 202 projecting upwards. A second application of torque by the manipulator received in the proximal end would then separate the proximal end from the body portion. The proximal end could then be separated from the manipulator and directed to a waste container. After the desired processing, the body portion can also be released into a waste container.

Other physical features may be provided that weaken the interface between the main body 220 and either or both of the distal end 208 and the proximal end 202. Alternatively, one or both of these interfaces may be cut such as through the use of a knife edge, a saw, or a heated blade.

An alternative approach includes aspirating a sample or samples into the microfluidic circuit 228 of the body portion 220 and the required channels are occluded, such as through localized heating. The IMU 200 is then moved into a processing station that is capable of gripping the body portion 220. The manipulator engaging the proximal end 202 is withdrawn. The proximal end and the distal end 208 are then severed from the body portion such as through actuated surfaces being driven laterally into the IMU above and below the body portion. Or, the body portion may be moved by the engaging manipulator such that the proximal end and distal ends are brought into contact with stationary surfaces for the purpose of breaking the ends from the body portion. Fracturable regions 250 may facilitate this separation. After the desired processing, the body portion is either engaged by the same or an additional manipulator for subsequent movement and processing or is dropped into a waste container.

It will be understood that certain features and sub-combinations are of utility and may be employed without reference to other features and sub combinations and are contemplated within the scope of the claims. Not all steps listed in the various figures need be carried out in the specific order described.

I claim:

1. An integrated microfluidic unit, comprising:
a distal end having an inlet in fluid communication with an inlet fluid channel;
a proximal end, opposite the distal end, comprising an outlet in fluid communication with an outlet fluid channel and comprised of a manipulator interface and a body interface; and
a body region, intermediate the distal end and the proximal end, the body region having a microfluidic circuit in fluid communication with each of the inlet fluid channel and the outlet fluid channel,
wherein the manipulator interface is configured to be selectively and mechanically acquired by a translating and aspirating manipulator.

2. The integrated microfluidic unit of claim 1, wherein the distal end is tapered such that an outer dimension of the distal end proximate the inlet is narrower than an outer dimension of the distal end proximate the body region.

3. The integrated microfluidic unit of claim 1, wherein the manipulator interface is a socket dimensioned to selectively receive a portion of the translating and aspirating manipulator therein.

4. The integrated microfluidic unit of claim 1, wherein the body interface is intermediate the manipulator interface and the body region and comprises at least one fluid channel therebetween.

5. The integrated microfluidic unit of claim 4, wherein the body interface is tapered such that an outer dimension of the body interface proximate the manipulator interface is wider than an outer dimension of the body interface proximate the body region.

6. The integrated microfluidic unit of claim 1, wherein the outer surface of the manipulator interface is substantially cylindrical.

7. The integrated microfluidic unit of claim 6, wherein the cylindrical outer surface is dimensioned to be selectively received within an aperture of a rack.

8. The integrated microfluidic unit of claim 6, wherein the manipulator interface further comprises abutments disposed about the periphery of the manipulator interface.

9. The integrated microfluidic unit of claim 8, wherein the abutments are regularly disposed about the periphery of the manipulator interface.

10. The integrated microfluidic unit of claim 8, wherein the abutments are linear projections axially aligned with an axis of symmetry of the manipulator interface.

11. The integrated microfluidic unit of claim 10, wherein the abutments each have a lower face, substantially orthogonal to the adjacent outer surface of the manipulator interface, configured to be selectively disposed upon an upper surface of a rack when the integrated microfluidic unit is disposed within the rack.

12. The integrated microfluidic unit of claim 1, wherein the microfluidic circuit comprises at least one circuit channel and a reservoir.

13. The integrated microfluidic unit of claim 12, wherein the at least one circuit channel is selectively sealable.

14. The integrated microfluidic unit of claim 1, wherein a maximum width of the body region is equal to or less than the maximum width of the outer surface of the manipulator interface.

15. The integrated microfluidic unit of claim 1, wherein the distal end, proximal end, and body region are formed as a unitary structure.

16. The integrated microfluidic unit of claim 1, wherein the translating and aspirating manipulator is one of a pipette head or a syringe.

17. The integrated microfluidic unit of claim 1, further comprising at least one fracturable region intermediate the body region and one or both of the proximal end and the distal end, the fracturable region enabling the selective physical separation of the body region and one or both of the proximal end and the distal end.

18. A method of performing microfluidic analysis of a fluid sample, comprising:
providing an integrated microfluidic unit comprised of
a distal end having an inlet in fluid communication with an inlet fluid channel,
a proximal end, opposite the distal end, comprising an outlet in fluid communication with an outlet fluid channel and comprised of a manipulator interface, configured to be selectively acquired by a selectively translating and aspirating manipulator, and a body interface, and
a body region, intermediate the distal end and the proximal end, the body region having a microfluidic circuit in fluid communication with each of the inlet fluid channel and the outlet fluid channel;
acquiring the integrated microfluidic unit with the selectively translating and aspirating manipulator;
aspirating a sample of a fluid through the distal end;
drawing at least a portion of the sample into the microfluidic circuit; and
analyzing the sample within the microfluidic circuit.

19. The method of claim 18, wherein acquiring the integrated microfluidic unit with the selectively translating and aspirating manipulator comprises inserting a portion of a selectively translating and aspirating manipulator within the manipulator interface.

20. The method of claim 19, wherein the integrated microfluidic unit is acquired through friction fit between the portion of the selectively translating and aspirating manipulator and the manipulator interface.

21. The method of claim 19, wherein the integrated microfluidic unit is acquired through interference of mechanical features disposed with respect to at least one of the portion of the selectively translating and aspirating manipulator and the manipulator interface.

22. The method of claim 18, further comprising translating the selectively translating and aspirating manipulator to dispose the distal end into a quantity of fluid prior to aspirating the sample.

23. The method of claim 18, wherein drawing at least a portion of the sample into the microfluidic circuit comprises actuating a source of vacuum in communication with the selectively translating and aspirating manipulator.

24. The method of claim 23, wherein drawing at least a portion of the sample into the microfluidic circuit comprises drawing the sample into a first channel.

25. The method of claim 24, wherein drawing at least a portion of the sample into the microfluidic circuit comprises sealing the first channel and drawing the sample into a reservoir.

26. The method of claim 25, wherein drawing at least a portion of the sample into the microfluidic circuit comprises sealing an entrance and an exit of the reservoir prior to analyzing the sample.

27. The method of claim 18, further comprises removing the integrated microfluidic unit from the selectively translating and aspirating manipulator after analyzing the sample.

28. The method of claim 27, where removing the integrated microfluidic circuit from the selectively translating and aspirating manipulator comprises translating the selectively translating and aspirating manipulator proximate a lateral plane, disposing at least a portion of the proximal end, and raising the selectively translating and aspirating manipulator.

29. The method of claim 18, wherein the translating and aspirating manipulator is one of a pipette head or a syringe.

30. The method of claim 18, wherein the step of providing further comprises providing the integrated microfluidic unit further comprised of at least one fracturable region intermediate the body region and at least one of the distal end and the proximal end, and
wherein the method further comprises the step of selectively severing the at least one fracturable region.

31. The method of claim 18, further comprising selectively severing the body portion from one or both of the proximal end and the distal end.

32. The method of claim 31, wherein selectively severing comprises breaking the integrated microfluidic unit at a fracturable region.

33. The method of claim 31, wherein selectively severing comprises selectively separating the body portion from one or both of the proximal end and the distal end using one of a cold blade, a heated blade, and a serrated blade.
